(19) United States
(12) Patent Application Publication
(10) Pub. No.: US 2023/0230111 A1
(43) Pub. Date: Jul. 20, 2023

(54) DEMAND FORECASTING FOR TRANSPORTATION SERVICES

(71) Applicant: OneSky Flight LLC, Richmond Heights, OH (US)

(72) Inventors: Durga Nagalla, Richmond Heights, OH (US); Michael Campobasso, Richmond Heights, OH (US); William Lanphear, Richmond Heights, OH (US); Tyler Wise, Richmond Heights, OH (US); Zack Hagerty, Richmond Heights, OH (US); James Blake, Richmond Heights, OH (US)

(73) Assignee: OneSky Flight LLC, Richmond Heights, OH (US)

(21) Appl. No.: 18/098,047

(22) Filed: Jan. 17, 2023

Related U.S. Application Data
(60) Provisional application No. 63/300,544, filed on Jan. 18, 2022.

(51) Int. Cl. G06Q 30/0202; G06N 3/08; G06N 3/045

(52) U.S. Cl. CPC G06Q 30/0202; G06N 3/08; G06N 3/045

(57) ABSTRACT

Embodiments described herein are related to systems and methods for forecasting demands for a transportation service. In one aspect, a set of neural network models may be implemented, where each neural network model can be configured to predict a booking status of a category of carriers on a corresponding date from a range of dates before a departure date. In one aspect, for each neural network model, a corresponding set of configuration values can be determined. Examples of the corresponding set of configuration values includes at least one of a number of layers, a number of neurons, and an activation function of the each neural network model. The set of neural network models can be constructed, according to corresponding sets of configuration values, and the constructed neural network models can be trained.

### CROSS-REFERENCE TO RELATED APPLICATION

This application claims priority to U.S. Provisional Application No. 63/300,544, filed Jan. 18, 2022, which is incorporated by reference in its entirety.

### TECHNICAL FIELD

This application relates generally to computing processes and machine-learning techniques for demand forecasting for transportation services.

### BACKGROUND

Developments in electronic devices and communication have allowed ease of reserving transportation services (e.g., aircraft charters, airline carriers, rental cars, for-hire drivers, mass transit). For example, a user can search for a flight leaving on a selected departure date through a client device. The client device may query a booking system of the travel provide, or issue a query to a search engine operated by a travel service provider or a travel agency, for available flights on the selected departure date, and receive a list of available flights or carriers for the selected departure date in return. The client device may present the list of available flights or carriers to the user and allow the user to select and reserve a flight. Other transportation service industries and third-party agencies and aggregation services (e.g., Expedia®, Kayak®) implement similar travel-related systems and software applications.

Travel service companies typically set prices through any number of algorithms based on various factors, such as supply-and-demand, historic demand, and date-of-departure. Due to the volume of data and need for real time pricing mechanisms, travel companies employ large-scale computing systems to query internal data records and calculate and report the prices.

### SUMMARY

Existing travel industry systems employ price forecasting based on historic data analytics and travel itinerary recommendation or personalization engines. These prior approaches, however, are based on conventional big data analytics and statistical analysis, and such approaches merely address pricing or the traveler's itinerary.

Travel service systems could be improved by employing machine-learning architectures to better predict demand and manage supply, particularly for the types of travel services that generally have limited supply, experience acute demand spikes or drops (e.g., seasonal fluctuations, particular annual events at a location, time-of-day fluctuations). Moreover, demand and bookings often do not change linearly with respect to the number of days remaining before the travel date (sometimes referred to as “departure date” or “date of departure”). As such, travel service systems could be further improved with systems and methods implementing a machine-learning architectures that account for non-linear fluctuations in demand.

Embodiments disclosed herein may address shortcomings in the art and may provide additional or alternative improvements or benefits. The embodiments include systems and methods implementing machine-learning architectures for forecasting demand for travel services (e.g., aircraft charters, airline carriers, rental cars, for-hire drivers, mass transit). The embodiments implement a machine-learning architecture including a neural network architecture that comprises a set of neural network models tailored for a corresponding set of dates prior to the a departure date, and updating or adjusting the set of neural network models. By implementing different neural network models, non-linear change in demands or booking statuses for transportation services for the range of dates before the departure date can be predicted in an accurate manner. Each neural network model may be uniquely trained for the particular day-before-travel using historic data for the particular date over several years and/or using historic data for the same day-before-travel.

Embodiments may further include software for manually or automatically constructing or tailoring the neural network models. Before, during, or after training the neural network models, the software may execute any number of simulations of the machine-learning architecture that applies each neural network model on historic, simulated, or live (real-life) data and outputs one or more performance metrics for some or all of the neural network models. Based on the performance metrics, the software may automatically, or an administrative user could manually, adjust or update the neural network model to improve accuracy or efficiency. Updating or adjusting a neural network model may include determining a set of configuration values, and training the neural network model according to the determined set of configuration values. Examples of a set of configuration values of a neural network model include a number of layers, a number of neurons, and an activation function. According to the set of configuration values, a neural network model can be constructed and a set of configuration parameters, such as weight values and/or bias values, can be adjusted through training.

In some embodiments, a computer-implemented method comprises receiving, by a computer, a plurality of historic travel records for a plurality of upcoming dates relative to an upcoming travel date; generating, by the computer, a plurality of neural network models of a machine-learning architecture, the plurality of neural network models including a neural network model associated with a corresponding upcoming date of the plurality of dates; applying, by the computer, each neural network model on a set of one or more historic travel records for the upcoming date corresponding to the neural network model to train each of the neural network models; receiving, by the computer, input travel data associated with a client device, the input travel data comprising one or more attributes including the upcoming travel date; and generating, by the computer, a report indicating a predicted demand for the upcoming travel date and each of upcoming dates of the plurality of dates before the upcoming travel date by applying the one or more neural network models on the input travel data associated with the client device.

In some embodiments, a system comprises a computer comprising one or more processors configured to: receive a plurality of historic travel records for a plurality of upcoming dates relative to an upcoming travel date; generate a plurality of neural network models of a machine-learning architecture, the plurality of neural network models including a neural network model associated with a corresponding upcoming date of the plurality of dates; apply each neural network model on a set of one or more historic travel records for the upcoming date corresponding to the neural network model to train each of the neural network models; receive input travel data associated with a client device, the input travel data comprising one or more attributes including the upcoming travel date; and generate a report indicating a predicted demand for the upcoming travel date and each of upcoming dates of the plurality of dates before the upcoming travel date by applying the one or more neural network models on the input travel data associated with the client device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification, illustrate an embodiment of the invention, and, together with the specification, explain the invention.

FIG. 1 illustrates a computer system for reserving transportation service, in accordance with an embodiment.

FIG. 2 illustrates a demand forecast system, in accordance with an embodiment.

FIG. 3 illustrates an example input data to train a neural network model, in accordance with an embodiment.

FIG. 4 illustrates an example plot showing predicted booking statuses for a range of dates before a departure date, in accordance with an embodiment.

FIG. 5 illustrates a method of generating a report indicating a forecast of booking statuses through neural network models, in accordance with an embodiment.

FIG. 6 illustrates a method of determining different sets of configuration values for neural network models, in accordance with an embodiment.

FIG. 7 illustrates a method of determining a set of configuration values for a neural network model, in accordance with an embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Various embodiments disclosed herein are related to a system and a method for generating a forecast of demands or booking statuses for transportation services (e.g., aircraft scheduling, rental car scheduling) or other resource scheduling sensitive to demand. The embodiments implement a machine-learning architecture including a neural network architecture comprising a set of neural network models for a corresponding set of days before a departure date, and updating or adjusting the set of neural network models. The neural network models may implement one or more types of neural network architecture or machine-learning techniques or functions, including convolutional neural networks (CNNs), deep neural networks (DNNs), recurrent neural networks, and long short-term memory recurrent neural networks (LSTM RNNs), among others. Each neural network model can predict a demand or a booking status for a transportation service at a corresponding day before the departure date. For example, the neural network architecture includes 60 neural network models trained to predict changing demands or booking statuses of a transportation service for a 60-day window prior to the departure date. In this example, the neural network architecture comprises the 60 neural network models trained specifically for each particular day or pre-configured set of days (each week, each 4-day set) prior to the departure day. Where the neural network architecture is configured for demand forecasting 60 days prior to the departure date, the neural network architecture may comprise a neural network model trained for 60 days from departure (“60-day neural network model”), another neural network model trained for 59 days from departure (“59-day neural network model”), another neural network model trained for 58 days from departure (“58-day neural network model), and so on. In some cases the neural network architecture would include a 61st neural network model for the day of departure (“0-day neural network model”). In this way, embodiments implement various neural network models to account for the non-linear change in demand or booking statuses for transportation services for the range of days before the departure date, thereby improving the accuracy of the demand forecasted for the departure date and for the intermediate dates.

The example embodiments provided herein implement the machine-learning architectures for predicting demand or managing the reservations, scheduling, and bookings for aircraft transportation, but embodiments are not so limited. Embodiments may implement machine-learning architectures to predict demand or managing reservations, scheduling, and bookings for various types of transportation services, various different carriers within a particular transportation service industry, or various different transportation service offerings within a particular company.

Each neural network model can be trained by providing input data with attributes. Input data may indicate a booking status for a particular date before a departure date. Additionally, the input data may indicate or include other attributes, such as an event scheduled at the departure date, a particular day of a week, a particular week of a year, a holiday, or a pandemic status, etc. By providing input data with attributes to train neural network models, the neural network models can predict demands or booking statuses in view of such attributes. For example, a neural network model can predict an increase in demand, if a super bowl event is scheduled on or near the departure date. For example, a neural network model can predict a decrease in demand, if a number of pandemic cases reported in a particular place or country has increased. As another example, a neural network model may be trained to predict an increase in demand to particular cities at a time of year (e.g., winter to skiing destinations) or around a particular event on or near the departure date (e.g., increased demand for an increasing number of days preceding New Year's Eve where New York is the destination).

Embodiments may further include software for manually or automatically constructing or tailoring the neural network models. Before, during, or after training the neural network models, the software may execute any number of simulations of the machine-learning architecture that applies each neural network model on historic, simulated, or live (real-life) data and outputs one or more performance metrics for some or all of the neural network models. Based on the performance metrics, the software may automatically, or an administrative user could manually, adjust or update the neural network model to improve accuracy or efficiency. Updating or adjusting a neural network model may include determining a set of configuration values, and training the neural network model according to the determined set of configuration values. Examples of a set of configuration values of a neural network model include a number of layers, a number of neurons, and an activation function. According to the set of configuration values, a neural network model can be constructed and a set of configuration parameters, such as hyper-parameters, weight values, and/or bias values, can be adjusted through training.

In some implementations, the neural network models can be updated or adjusted in groups or in sets in a continuous manner. For example, a first set of configuration values for a first set of neural network models corresponding to a first range of dates before a departure date can be determined, and a second set of configuration values for a second set of neural network models corresponding to a second range of dates before the departure date can be determined. The first set of configuration values and the second set of configuration values can be determined in parallel to reduce computation time. After determining the first set of configuration values and the second set of configuration values, a third set of configuration values for a third set of neural network models corresponding to a third range of dates before the departure date can be determined, and a fourth set of configuration values for a fourth set of neural network models corresponding to a fourth range of dates before the departure date can be determined.

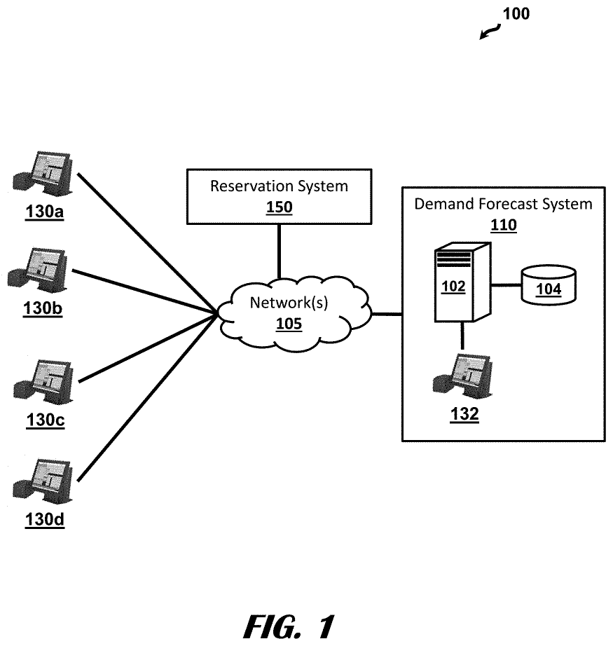

FIG. 1 illustrates a computer system 100 for reserving transportation service, in accordance with an embodiment. In some embodiments, the system 100 includes a reservation system 150, any number of client computing devices 130 (e.g., client devices 130a-130d), and a demand forecast system 110, which communicate via one or more communication network 105. The demand forecast system 110 includes one or more servers 102, one or more databases 104, and any number of admin devices 132. Embodiments may comprise additional or alternative components or omit certain components from those of FIG. 1, and still fall within the scope of this disclosure. For example, the system 100 may include a third-party system that communicates with the client devices 130, the reservation system 150, the demand forecast system 110, or any combination thereof, through the network 105. Embodiments may include or otherwise implement any number of devices capable of performing the various features and tasks described herein. For example, FIG. 1 shows the reservation system 150 and the demand forecast system 110 as distinct computing systems, though the reservation system 150 and the demand forecast system 110 may be implemented as a single system or operated by a single entity.

The various components of the system 100, the reservation system 150, the demand forecast system 110 (including the server 102, database 104, and admin device 132), and the client devices 130 may be connected with each other via hardware and software components of one or more system networks 105 or internal networks. Examples of such networks 105 include, but are not limited to, Local Area Network (LAN), Wireless Local Area Network (WLAN), Metropolitan Area Network (MAN), Wide Area Network (WAN), and the Internet. The communication over any particular network 105 may be performed in accordance with various communication protocols, such as Transmission Control Protocol and Internet Protocol (TCP/IP), User Datagram Protocol (UDP), and IEEE communication protocols, among others.

The client device 130 and admin device 132 are computing devices operated by a user or administrative user of the demand forecast system 110. The client device 130 and admin device 132 include any computing device having computing hardware (e.g., processors, non-transitory memory) and software for performing the various processes and tasks described herein. Non-limiting examples of the client device 130 or the admin device 132 include smart phones, servers, desktops, laptops, tablets, and the like.

The client device 130 executes software accessing the reservation system 150 or demand forecast system 110 and allows the user to reserve a travel service. For example, the client device 130 presents a user interface allowing the user to search for a transportation service (e.g., flights). The client device 130 may receive a user selection of a destination and/or a departure date, and query the reservation system 150 for available transportation services meeting the user selection. From the reservation system 150, the client device 130 may receive a list of available transportation services with associated fare amounts or fees, and present the list of available transportation services with the associated fare amounts or fees to the user through a user interface. Through the user interface, the client device 130 may receive a user selection of a desired transportation service, and notify the user selection to the reservation system 150 to execute or complete the reservation of the transportation service.

The admin device 132 executes software for accessing and configuring the components of the demand forecast system 110, including the server 102 and the database 104. The admin device 132 may, for example, allow the administrative user to select or enter (i.e., code, program) the various functional configurations of the machine-learning architecture, which the admin device 132 provides to the server 102 to construct or adjust the components of the machine-learning architecture. In some implementations, the admin device 132 receives various performance metrics for the machine-learning architecture (e.g., accuracy of neural network models, efficiency of neural network models), as generated by the server 102 when executing simulations of the machine-learning architecture. The admin device 132 may present the performance metrics to the administrative user via a user interface. The administrative user may further adjust the configurations of the machine-learning architecture using the user interface. Additionally or alternatively, the server 102 may automatically adjust the configurations of the machine-learning architecture and the neural network models based on the performance metrics, which the server 102 may execute before, during, or after training the neural network models.

The reservation system 150 includes one or more computing devices (e.g., server computers, desktop computers) that execute software that assist users with reserving a transportation service. The reservation system 150 may be operated by a transportation service provider, a travel agency, or a third-party agency. The reservation system 150 may receive, from the client device 130 a request for a list of available transportation services for a particular destination and/or the departure date. In response to the request, the reservation system 150 may identify available transportation services for the particular destination and/or the departure date and associated fare amounts or fees for each transportation service. The reservation system 150 may generate a list indicating the available transportation services with associated fare amounts or fees, and provide the list to the client device 130. The reservation system 150 may receive a user selection of the desired transportation service and process the reservation of the transportation service by booking the transportation service for the client device 130 or by notifying the transportation service provider.

The server 102 of the demand forecast system 110 is a computing device that predicts demands for transportation services. In some cases, the demand forecast system 110 may be operated by the same entity that operates the reservation system 150. Alternatively, the demand forecast system 110 may be operated by a different entity that operates the reservation system 150. The server 102 obtains prior records of bookings or reservations of transportation services from the client devices 130, the database 104 of the demand forecast system 110, and/or external database of the reservation system 150, and implements neural network models according to the prior records to predict future demands or booking statuses of transportation services. Each neural network model may predict a demand or booking status for a corresponding day before a departure date. For example, a first neural network model may be configured and trained to predict a demand or booking status ten days before the departure date, and a second neural network model may predict a demand or booking status nine days before the departure date. Hence, by implementing different neural network models, the server 102 may implement a machine-learning architecture that better determines predicted demands or booking statuses for a range of dates before the departure date by accounting for non-linear fluctuations in the demand. The server 102 of the demand forecast system 110 generates a report containing demand prediction data indicating the predicted demands or booking statuses for the date of departure and each intermediate day as outputted by the machine-learning architecture, and transmits the report to the reservation system 150. Based on the report, the reservation system 150 can adjust fare amounts or fees for transportation services or allocate transportation services to or from other companies (e.g., allocate aircraft or other vehicle, request or borrow aircraft or other vehicle)

The database 104 of the demand forecast system 110 may be hosted on any computing device of the demand forecast system 110 comprising non-transitory machine-readable storage media, which may include the server 102 or other computer device. The database 104 may store various configurations and parameters of the layers and functions of the machine-learning architecture, such as the number and types of functions performed by the neural network models or the set of parameters (e.g., trained hyper-parameters or weights) of the neural network models. The database 104 may further store historic, simulated, or live travel data records of various types, which in some cases the database 104 stores with training labels for training the machine-learning architecture. The server 102 may query database 104 and apply the machine-learning architecture against the relevant sets of travel data records during training or simulation operations. The server 102 may then tune the set of parameters (e.g., hyper-parameters or weights) of the neural network models to improve the accuracy of the neural network models using the training labels. For instance, the server 102 may tune or adjust one or more parameters of a neural network model when a predicted demand output generated by the neural network model does is inaccurate or fails an accuracy threshold with respect to an expected output indicated by the training labels, where the server 102 references attributes of the training labels to determine the expected output and the accuracy. Additionally or alternatively, the server 102 may automatically adjust the functions performed by the neural network models, such as adjusting the number of neurons or changing the activation functions, based upon the performance metrics of the neural network models when applied to the travel data records in the database 104.

In some embodiments, computing devices of the system 100, such as a reservation server of the reservation system 150, or the server 102 or admin device 132 of the demand forecast system 110, may perform any number of downstream operations and/or transmit the forecasting results to computing devices of one or more downstream transportation systems. For instance, the server 102 (or other computing device of the system 100) may determine the forecasted demand for a particular date and apply that forecast demand output against resource data to determine resource allocation requirements for the particular date. As an example, the server 102 may determine the forecast demand for a particular transportation service (e.g., flight for a particular departure-arrival pairing) on a particular date. The server 102 may then query one or more databases (e.g., database 104) to determine a number of resources (e.g., number of planes) currently allocated for the service (e.g., planes allocated for the particular flight itinerary or departure airport). The database 104 may further include additional data about the available transportation services, such as information about current or prior reservation itineraries. Using the forecast demand output for a particular date and the information about the transportation services, the server 102 of the demand forecast system 110 or device of the downstream system may identify a surplus or shortfall in available transportation on a particular date.

The server 102 may transmit a request or instructions to the downstream systems to reallocate the resources in advance of the particular date, based upon the forecasted demand. For example, the server 102 (or other computing device) may determine that the number of planes allocated on the particular date to a particular itinerary or departure airport falls short of the forecast demand or falls short of a threshold deficiency amount. In this example, the server 102 may automatically transmit a request to allocate airplanes to one or more downstream scheduling or reservation systems, where the request indicates information about the airplanes that should be allocated to allocated to the departure airport. As another example, the server 102 (or other computing device) may determine that the number of planes allocated on the particular date to the particular itinerary or departure airport exceeds the forecast demand or satisfies a threshold surplus amount. In this example, the server 102 may broadcast an advertisement to allocate airplanes to one or more downstream scheduling or reservation systems, where the request indicates information about the airplanes available to be reallocated from a particular departure airport.

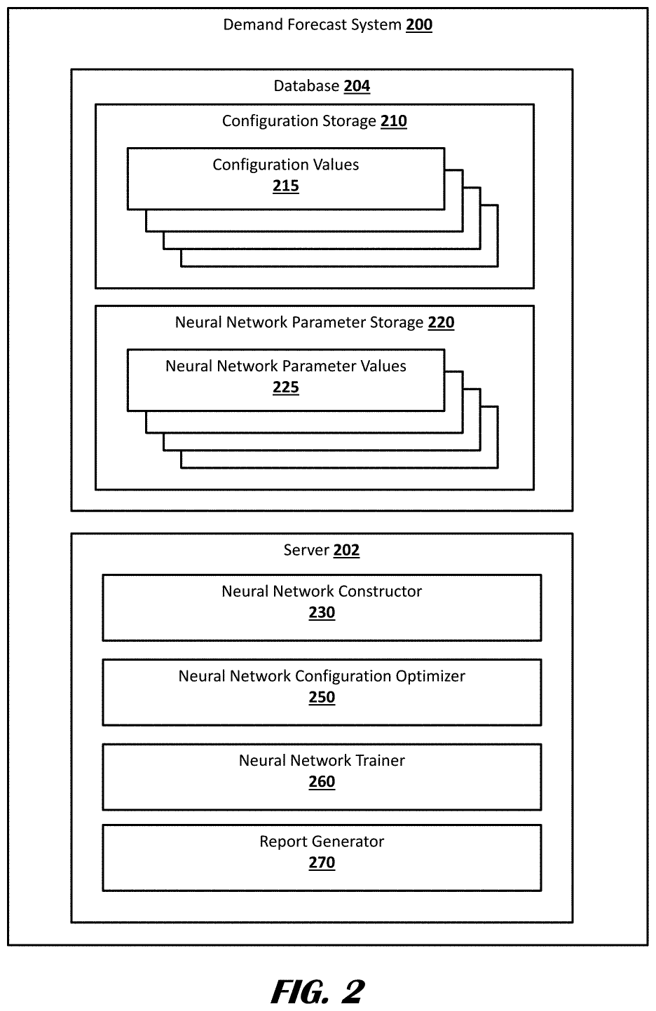

FIG. 2 illustrates components of a demand forecast system 200, in accordance with an embodiment. The demand forecast system 200 includes a database 204 comprising non-transitory, machine-readable memory including a configuration storage 210 and a neural network parameter storage 220. The demand forecast system 200 further includes a server 202 comprising one or more processors configured to execute various types of software, including a neural network constructor 230, a neural network configuration optimizer 250, a neural network trainer 260, and a report generator 270. These components may operate together to implement a set of neural network models to predict demands or booking statuses for transportation services, and adjust or update the set of neural network models corresponding to each of the days prior to travel. In some embodiments, the demand forecast system 200 includes more, fewer, or different components than shown in FIG. 2.

The configuration storage 210 of the database 204 is a component that stores one or more sets of configuration values 215 for functions or layers of a machine-learning architecture executed by the server 202. A set of configuration values 215 may be associated with a corresponding neural network model of the machine-learning architecture. Examples of a set of configuration values 215 of a neural network model include a number of layers, a number of neurons, and an activation function.

The neural network parameter storage 220 of the database 204 is a component that stores one or more neural network parameter values 225 (also referred to as “parameter values 225” herein). A set of parameter values 225 may be associated with a corresponding neural network model or other functions or layers of the machine-learning architecture executed by the server 202. Examples of a set of parameter values 225 of a neural network model include hyper-parameters, weight values, and/or bias values.

The server 202 executes a neural network constructor 230 that generates or constructs aspects of certain layers or functions that define one or more neural network models. In some cases, the neural network constructor 230 generates or adjusts the aspects of the neural network models based upon inputs or instructions received from an admin device configuring the particular neural network models. Additionally or alternatively, in some cases, the neural network constructor 230 operates in conjunction with the neural network configuration optimizer 250 to automatically generate or adjust the aspects of the neural network models based on performance metrics (e.g., prediction accuracy, operational efficiency) determined by the server 202 as compared to one or more corresponding threshold values. The neural network constructor 230 and neural network configuration optimizer 250 may, for example, increase or decrease a number of neurons or change the activation function of a certain neural network model when the prediction accuracy or efficiency fails to satisfy a corresponding threshold. To construct a neural network model, the neural network constructor 230 may retrieve a set of configuration values 215 of the neural network model from the configuration storage 210, and retrieve a set of parameter values 225 of the neural network model from the neural network parameter storage 220. Alternatively, the neural network constructor processor 230 may receive the configuration values 215 and/or the set of parameter values 225 from an admin device via a user interface. According to the set of configuration values 215 and the parameter values 225, the neural network constructor 230 can implement or construct a neural network model. For example, the neural network constructor 230 may implement a neural network model having a number of layers and a number of neurons with activation functions as indicated by the configuration values 215. For example, the neural network constructor 230 may set weight values or bias values as indicated by the parameter values 225. In case a set of configuration values 215 of a neural network model does not exist, the neural network constructor 230 may implement or construct the neural network model according to a default set of configuration values 215. Similarly, in case a set of parameter values 225 of a neural network model does not exist, the neural network constructor 230 may implement or construct the neural network model according to a default set of parameter values 225.

The neural network configuration optimizer 250 executed by the server 202 is a component that determines, for different neural network models, corresponding sets of configuration values 215 and/or parameter values 215. In one approach, the neural network configuration optimizer 250 determines multiple sets of configuration values 215 of neural network models associated with continuous dates. The neural network configuration optimizer 250 may determine two or more sets of configuration values 215 in parallel, to reduce computation time. For example, the neural network configuration optimizer 250 may determine a first set of configuration values for a first set of neural network models corresponding to 60 to 51 days before a departure date, while determining a second set of configuration values for a second set of neural network models corresponding to 50 to 41 days before the departure date. Then, the neural network configuration optimizer 250 may determine a third set of configuration values for a third set of neural network models corresponding to 40 to 31 days before a departure date, while determining a fourth set of configuration values for a fourth set of neural network models corresponding to 30 to 21 days before the departure date.

The neural network configuration optimizer 250 may determine, for a neural network model, a set of configuration values 215 including a number of layers, a number of neurons, and an activation function. In one example, the neural network configuration optimizer 250 may determine the set of configuration values 215 through a Bayesian optimization. For example, the neural network configuration optimizer 250 may obtain, for a neural network model, a candidate set of configuration values. The candidate set of configuration values may be an existing set of configuration values 215 or an initial set of configuration values 215 from the configuration storage 210. The neural network configuration optimizer 250 may cause the neural network constructor 230 to implement or construct the neural network model according to the candidate set of configuration values 215. The neural network configuration optimizer 250 may also cause the neural network trainer 260 to train the neural network model to adjust the parameter values 225 (e.g., weight values or bias values). The neural network configuration optimizer 250 may determine whether the accuracy of the output or prediction by the neural network model exceeds a threshold value or not. In response to the accuracy of the output or prediction by the neural network model not exceeding the threshold value, the neural network configuration optimizer 250 may adjust the candidate set of configuration values 215, and repeat the process. In one aspect, the candidate set of configuration values 215 are altered or adjusted through a guided learning, such that the neural network model constructed according to the adjusted candidate set of configuration values 215 can generate an output or prediction with higher accuracy. In response to the accuracy of the output or prediction by the neural network model exceeding the threshold value, the neural network configuration optimizer 250 may store the candidate set of configuration values as the set of configuration values for the neural network model.

The neural network trainer 260 is an operational function performed by the server 202 for the machine-learning architecture, when the server trains the neural network models to determine parameter values (e.g., weight values or bias values). In one approach, to train a neural network model, the report generator 270 causes the neural network constructor 230 to implement or construct the neural network model. The neural network trainer 260 may apply a test input to the neural network model to obtain a test output, and compare the test output with a target output value (or actual output for the test input). The neural network trainer 260 may determine, modify or adjust parameter values 225 (e.g., weights values or bias values) according to the comparison, such that the neural network model can generate an output that is close (e.g., ±5%) to the target output value (or actual output for the test input).

The report generator 270 is a component that generates a report indicating the predicted demands or booking statuses of a transportation service for a range of dates before the departure date. In one approach, the report generator 270 causes the neural network constructor 230 to implement or construct different neural network models associated with the range of dates before the departure date. The report generator 270 may apply, as an input, any event scheduled at the departure date, a particular day of a week, a particular week of a year, a holiday, or a pandemic status to the neural network models. Each neural network model may output forecast of demands or booking status for a corresponding date before the departure date, according to the input. The report generator 270 may compile outputs of the neural network models, and generate the report indicating the predicted demands or booking statuses of the transportation service in a graph form, a table form, or any format.

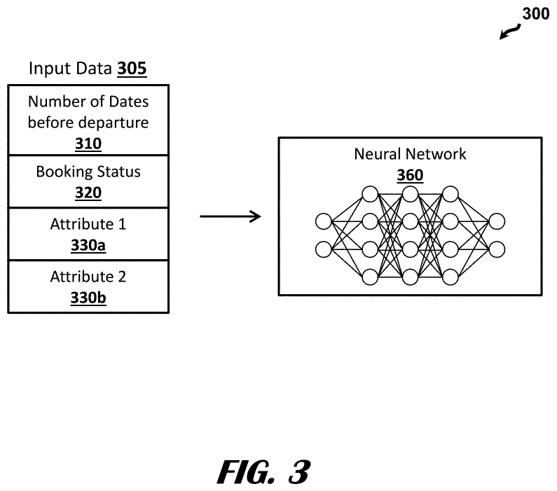

FIG. 3 illustrates a block diagram showing dataflow in a system 300 receiving input data 305 and executing software to apply a neural network 360 on the input data 305 during a training operation (e.g., neural network trainer 260 operation of FIG. 2). A computing device of the system 300 ingests and provides the input data 305 to the neural network model 360 to train the neural network model 360. In one example, the neural network model 360 may be configured to predict demand of a transportation service for a particular date before the departure date. The computing device trains the neural network model 360 by providing the input data 305 to the neural network model 360 as an input. The input data 305 may include a number of dates 310 before a departure date, a booking status or a booking record 320 on that date, and additional attributes 330a, 330b. Attributes 330a, 330b may be a particular day of a week, a particular week of a year, a holiday, or a pandemic status (e.g., number of recent cases). The input data 305 may include more or different attributes. By providing the input data 305 including the attributes 330a, 330b to train neural network models, the neural network model 360 can predict demands or booking statuses in view of such attributes 330a, 330b. For example, the neural network model 360 can predict an increase in demand to particular cities at a time of year (e.g., winter to skiing destinations) or around a particular event (e.g., the Holidays to New York) on or near the departure date. As another example of attributes 330a, 330b, the neural network model 360 can predict a decrease in demand, if a number of pandemic cases reported in a particular place or country has increased.

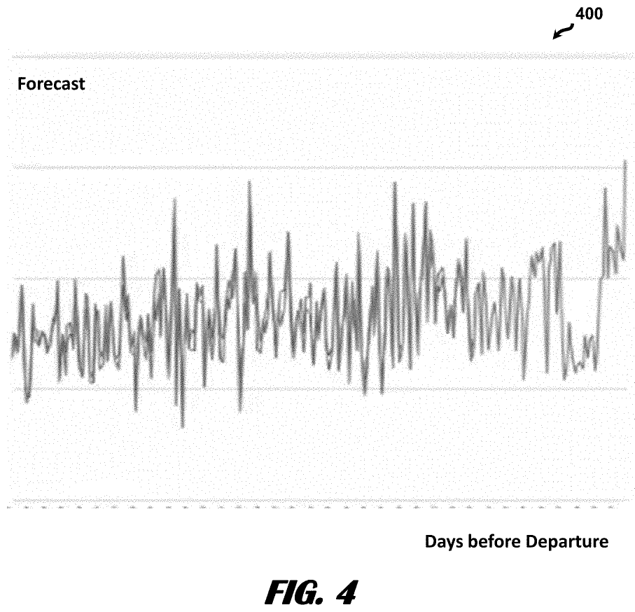

FIG. 4 illustrates an example plot 400 showing predicted booking statuses for a range of dates before a departure date, in accordance with an embodiment. In one example, the report generator 270 may cause the neural network constructor 230 to construct different neural network models for each date before the departure date, and cause each neural network model to predict a booking status. The report generator 270 may compile the outputs of the neural network models and generate a report in a graph form as shown in the plot 400. Additionally or alternatively, the report generator 270 may generate the report in a table form. The demand forecast may allow, for example, the reservation system 150 to adaptively change fare amounts or fees to reduce loss or increase gain, allocate excess transportation services to other companies, or borrow transportation services from other companies.

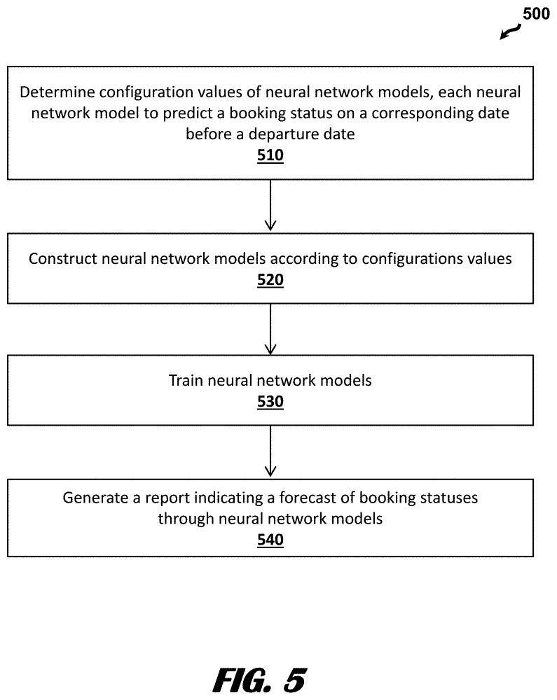

FIG. 5 illustrates a method 500 of generating a report indicating a forecast of booking statuses through neural network models, in accordance with an embodiment. The method 500 may be performed by the demand forecast system (e.g., by a server or computer of the demand forecast system). In some embodiments, the method 500 is performed by other entities. In some embodiments, the method 500 includes more, fewer, or different steps than shown in FIG. 5. For example, the steps 520, 530 may be omitted, or performed as part of or in conjunction with the step 510 or step 540.

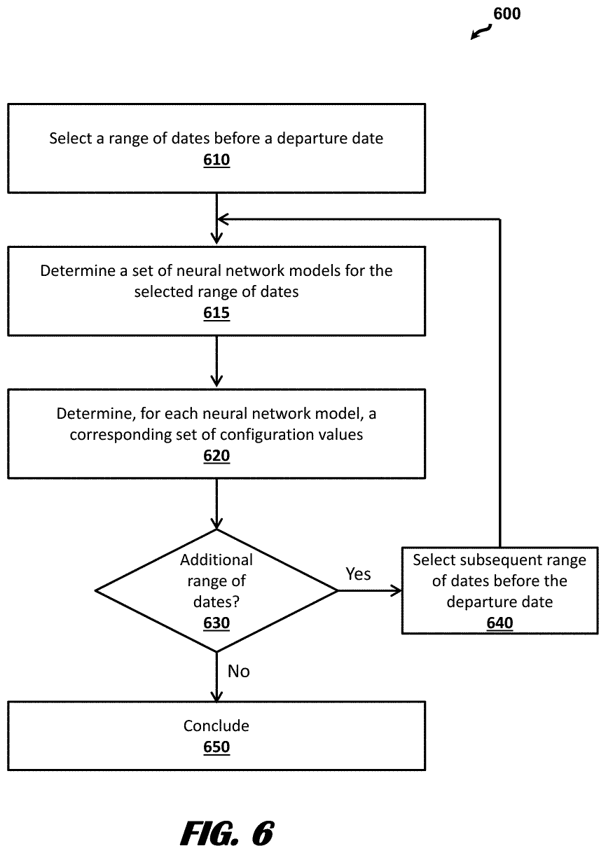

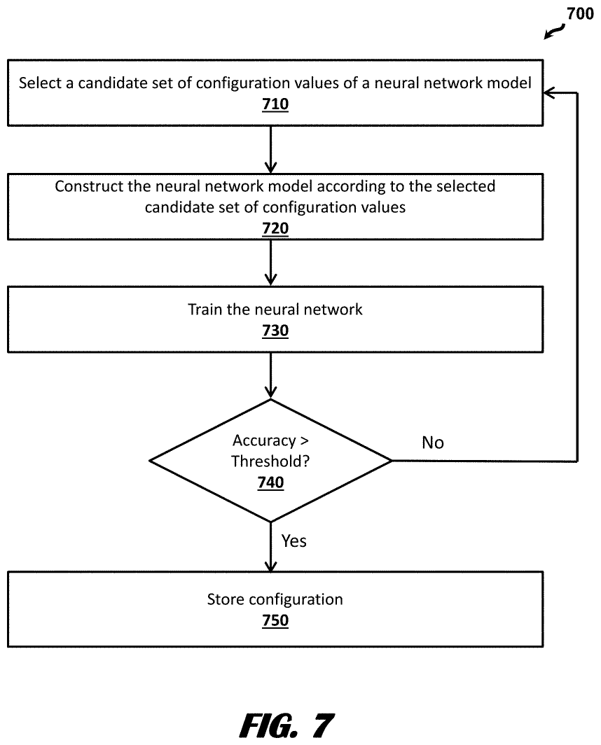

At step 510, the demand forecast system determines configuration values of neural network models. Each neural network model may be configured to predict a booking status on a corresponding date before a departure date. Examples of a set of configuration values of a neural network model include a number of layers, a number of neurons, and an activation function. The demand forecast system may determine the configuration values as described below with respect to FIGS. 6-7. The demand forecast system may store, for each neural network model, a corresponding set of configuration values by a configuration storage.

At step 520, the demand forecast system constructs neural network models, according to configurations values. The demand forecast system may construct each neural network model, according to a number of layers, a number of neurons, and an activation function as specified by the corresponding set of configuration values.

At step 530, the demand forecast system trains neural network models. In one approach, the demand forecast system may train a neural network model by applying a test input to the neural network model to obtain a test output, and comparing the test output with a target output value (or actual output for the test input). The demand forecast system may determine, modify or adjust parameter values (e.g., weights values or bias values) according to the comparison, such that the neural network model can generate an output that is close to the target output value (or actual output for the test input). In one aspect, training neural network models can be performed in the step 510, while determining configuration values. After determining the configuration values (e.g., number of layers, number of neurons, a type of activation function), the demand forecast system can train the neural network models to fine-tune the parameters value to further improve the accuracy of the outputs of the neural network models.

At step 540, the demand forecast system generates a report indicating a forecast of booking statuses through a set of neural network models for a range of dates before the departure date. In one approach, the demand forecast system causes each of the set of neural network models to output predicted booking status on a corresponding date within the range of dates. The demand forecast system may apply, as an input, any event scheduled at the departure date, a particular day of a week, a particular week of a year, a holiday, or a pandemic status to the neural network models. Each neural network model may output forecast of demands or booking status for a corresponding date before the departure date, according to the input. The demand forecast system may compile outputs of the neural network models, and generate the report indicating the predicted demands or booking statuses of the transportation service in a graph form, in a table form, or in any format. The demand forecast system may provide the report to the reservation system.

FIG. 6 illustrates a method 600 of determining different sets of configuration values for neural network models, in accordance with an embodiment. The method 600 may be performed as part of the step 510 in FIG. 5. The method 600 may be performed by the demand forecast system. In some embodiments, the method 600 is performed by other entities. In some embodiments, the method 600 includes more, fewer, or different steps than shown in FIG. 6.

At step 610, the demand forecast system selects a range of dates before a departure date. A range of dates may be a number of consecutive dates before the departure date. For example, the demand forecast system may select ten consecutive dates (e.g., 60 to 51 days before the departure date).

At step 615, the demand forecast system determines a set of neural network models for the selected range of dates. Each neural network model may be configured to generate as an output a predicted demand or booking status on a corresponding date from the range of dates before the departure date. For example, for a range of 10 consecutive dates selected, the demand forecast system may select 10 corresponding neural network models.

At step 620, the demand forecast system determines, for each neural network model, a corresponding set of configuration values. Examples of the set of configuration values of a neural network model include a number of layers, a number of neurons, and an activation function of the neural network model. For each neural network model, the demand forecast system may determine the set of configuration values through a Bayesian optimization. Example process of determining a set of configuration values for a neural network model is provided below with respect to FIG. 7.

At step 630, the demand forecast system determines whether configuration values of neural network models for an additional range of dates should be determined or not. At step 640, if configuration values of neural network models for an additional range of dates should be determined, the demand forecast system may select a subsequent range of dates before the departure date, and proceed to the step 615. For example, after determining the configuration values of neural network models for ten consecutive dates (e.g., 60 to 51 days before the departure date), the demand forecast system may determine the subsequent ten consecutive dates (e.g., 50 to 41 days before the departure date). At step 650, if no additional configuration values of neural network models should be determined, the demand forecast system may conclude the method 600.

FIG. 7 illustrates a method 700 of determining a set of configuration values of a neural network model, in accordance with an embodiment. The method 700 may be performed as part of the step 620 in FIG. 7. The method 700 may be performed by the demand forecast system. In some embodiments, the method 700 is performed by other entities. In some embodiments, the method 700 includes more, fewer, or different steps than shown in FIG. 7. For example, the step 730 may be omitted, or performed as part of or in conjunction with a different step.

At step 710, the demand forecast system selects a candidate set of configuration values of a neural network model. The candidate set of configuration values may be an existing set of configuration values or an initial set of configuration values from the configuration storage.

At step 720, the demand forecast system may implement or construct a neural network model according to the candidate set of configuration values. The demand forecast system may implement or construct the neural network model according to a set of parameter values (e.g., weight values or bias values) of the neural network model. The set of parameter values may be an existing set of parameter values or an initial set of parameter values from the neural network parameter storage.

At step 730, the demand forecast system may train the neural network. In one approach, the demand forecast system may train a neural network model by applying a test input to the neural network model to obtain a test output, and comparing the test output with a target output value (or actual output for the test input). The demand forecast system may determine, modify or adjust parameter values (e.g., weights values or bias values) according to the comparison, such that the neural network model can generate an output that is close to the target output value (or actual output for the test input). The demand forecast system may train the neural network model for a predetermined number of times, or until the accuracy of the prediction or output of the neural network model does not improve.

At step 740, the demand forecast system may test the accuracy of the prediction of the booking status or output of the neural network. For example, the demand forecast system may apply a test input to the neural network model to obtain a test output, and compare the test output with a target output value (or actual output for the test input). At step 750, if the accuracy is higher than a threshold value, then the demand forecast system may store the candidate set of configuration values as the set of configuration values for the neural network model. If the accuracy is less than the threshold value, then the demand forecast system may proceed to the step 710 and select a different candidate set of configuration values. For example, the demand forecast system may alter the number of layers, the number of neurons, and/or select a different activation function. Through the iterative process as shown in the method 700, a set of configuration values allowing the neural network model to generate output with high accuracy can be determined.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, function, procedure, subroutine, subprogram, or the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that is accessible by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. “Disk” and “disc”, as used herein, include compact disc (CD), laser disc, optical disc, digital versatile disc (DVD), floppy disk, and Blu-ray disc formats, wherein “disks” reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a computer, a plurality of historic travel records for a plurality of upcoming dates relative to an upcoming travel date;
generating, by the computer, a plurality of neural network models of a machine-learning architecture, the plurality of neural network models including a neural network model associated with a corresponding upcoming date of the plurality of dates;
applying, by the computer, each neural network model on a set of one or more historic travel records for the upcoming date corresponding to the neural network model to train each of the neural network models;
receiving, by the computer, input travel data associated with a client device, the input travel data comprising one or more attributes including the upcoming travel date; and
generating, by the computer, a report indicating a predicted demand for the upcoming travel date and each of upcoming dates of the plurality of dates before the upcoming travel date by applying the one or more neural network models on the input travel data associated with the client device.

2. The method according to claim 1, wherein training each of the neural network models includes determining, by a computer, for the particular neural network model a corresponding set of configuration parameters based upon the set of one or more historic travel records for the upcoming date corresponding to the neural network model.

3. The method according to claim 2, wherein training the particular neural network model includes:
determining, by the computer, an accuracy between a predicted output and an expected output of the particular neural network model as applied to the set of one or more historic travel records for the upcoming date; and
adjusting, by the computer, at least one configuration parameter of the neural network model based upon the accuracy of the prediction of the first neural network model failing to satisfy a threshold value for training.

4. The method according to claim 1, further comprising constructing, by the computer, each neural network model of the plurality of neural network models according to a corresponding set of configuration values, wherein the corresponding set of configuration values includes at least one of a number of layers, a number of neurons, and an activation function of the each neural network model.

5. The method according to claim 4, wherein, for each neural network model, the computer determines the corresponding set of configuration values by executing at least one optimization function.

6. The method according to claim 4, wherein constructing the neural network model according to the corresponding set of configuration values includes:
determining, by the computer performing a simulation operation, an accuracy of a prediction of the first neural network model by applying the first neural network model on a candidate set of configuration values.

7. The method according to claim 4, wherein constructing the neural network model according to the corresponding set of configuration values includes:
adjusting, by the computer, at least one configuration value of the neural network model based upon an accuracy of the prediction of the first neural network model failing to satisfy a threshold value for a simulation operation.

8. The method according to claim 4, further comprising receiving the set of configuration values via a user interface from a client device.

9. The method according to claim 1, wherein the plurality of historic travel records for training the neural network models comprises at least one attribute, including at least one of: an event scheduled at the upcoming travel date, a particular day of a week, a particular week of a year, a holiday, or a pandemic status of a location.

10. The method of claim 1, wherein the neural network model for a particular upcoming date comprises at least one of a convolutional neural network, a deep neural network, a recurrent neural network, and a long short-term memory recurrent neural network.

11. A system comprising:
a computer comprising one or more processors configured to:
receive a plurality of historic travel records for a plurality of upcoming dates relative to an upcoming travel date;
generate a plurality of neural network models of a machine-learning architecture, the plurality of neural network models including a neural network model associated with a corresponding upcoming date of the plurality of dates;
apply each neural network model on a set of one or more historic travel records for the upcoming date corresponding to the neural network model to train each of the neural network models;
receive input travel data associated with a client device, the input travel data comprising one or more attributes including the upcoming travel date; and
generate a report indicating a predicted demand for the upcoming travel date and each of upcoming dates of the plurality of dates before the upcoming travel date by applying the one or more neural network models on the input travel data associated with the client device.

12. The system according to claim 11, wherein when training each of the neural network models the computer is further configured to determine for the particular neural network model a corresponding set of configuration parameters based upon the set of one or more historic event records for the upcoming date corresponding to the neural network model.

13. The system according to claim 12, wherein when training each of the neural network models the computer is further configured to:
determine an accuracy between a predicted output and an expected output of the particular neural network model as applied to the set of one or more historic travel records for the upcoming date; and
adjust at least one configuration parameter of the neural network model based upon the accuracy of the prediction of the first neural network model failing to satisfy a threshold value for training.

14. The system according to claim 11, wherein the computer is further configured to construct each neural network model of the plurality of neural network models according to a corresponding set of configuration values, wherein the corresponding set of configuration values includes at least one of a number of layers, a number of neurons, and an activation function of the each neural network model.

15. The system according to claim 14, wherein, for each neural network model, the computer determines the corresponding set of configuration values by executing at least one optimization function.

16. The system according to claim 14, wherein when constructing the neural network model according to the corresponding set of configuration values the computer is further configured to:
determine, during a simulation operation, an accuracy of a prediction of the first neural network model by applying the first neural network model on a candidate set of configuration values.

17. The system according to claim 14, wherein when constructing the neural network model according to the corresponding set of configuration values the computer is further configured to:
adjust at least one configuration value of the neural network model based upon an accuracy of the prediction of the first neural network model failing to satisfy a threshold value for a simulation operation.

18. The system according to claim 14, wherein the computer is further configured to receive the set of configuration values via a user interface from a client device.

19. The system according to claim 11, wherein the plurality of historic travel records for training the neural network models comprises at least one attribute including at least one of: an event scheduled at the upcoming travel date, a particular day of a week, a particular week of a year, a holiday, or a pandemic status of a location.

20. The system according to claim 11, wherein the neural network model for a particular upcoming date includes at least one of a convolutional neural network, a deep neural network, a recurrent neural network, and a long short-term memory recurrent neural network.
